(19) United States
(12) Patent Application Publication
(10) Pub. No.: US 2020/0176780 A1
(43) Pub. Date: Jun. 4, 2020

(54) SECONDARY BATTERY AND METHOD FOR MANUFACTURING THE SAME

(71) Applicant: SANYO Electric Co., Ltd., Osaka (JP)

(72) Inventors: Kazuma Mima, Hyogo (JP); Haruya Nakai, Hyogo (JP)

(73) Assignee: SANYO Electric Co., Ltd., Osaka (JP)

(21) Appl. No.: 16/666,647

(22) Filed: Oct. 29, 2019

(30) Foreign Application Priority Data
Nov. 30, 2018 (JP) 2018-224379

(51) Int. Cl. H01M 4/66; H01M 10/0525

(52) U.S. Cl. CPC H01M 4/661; H01M 2004/027; H01M 10/0525

(57) ABSTRACT

A secondary battery includes a battery case and an electrode assembly housed therein. The electrode assembly includes a positive electrode plate including a positive electrode current collector and a positive electrode active material layer placed thereon and a negative electrode plate including a negative electrode current collector composed of copper foil or copper alloy foil and a negative electrode active material layer placed thereon. The negative electrode current collector is connected to a negative electrode external terminal attached to the battery case with a negative electrode current-collecting lead therebetween. The negative electrode current collector and the negative electrode current-collecting lead are joined together with a resistance weld. The diffraction intensity I(111) of a (111) orientation on a principal surface of the negative electrode current collector that is located on the negative electrode current-collecting lead side is larger than the diffraction intensity of another orientation as determined by X-ray diffraction.

### CROSS REFERENCE TO RELATED APPLICATIONS

The present invention application claims priority to Japanese Patent Application No. 2018-224379 filed in the Japan Patent Office on Nov. 30, 2018, the entire contents of which are incorporated herein by reference.

### BACKGROUND OF THE INVENTION

### Field of the Invention

The present invention relates to a secondary battery and a method for manufacturing the same.

### Description of Related Art

Secondary batteries such as lithium ion secondary batteries include an electrode assembly including a positive electrode and a negative electrode, a nonaqueous electrolyte, and a battery case in which the electrode assembly and the nonaqueous electrolyte are housed. The positive electrode includes a positive electrode current collector and a positive electrode active material layer formed thereon. The negative electrode includes a negative electrode current collector and a negative electrode active material layer formed thereon. The positive electrode active material layer and the negative electrode active material layer are made of an active material capable of reversibly storing and releasing, for example, charge carriers such as lithium ions.

In, for example, a lithium ion secondary battery, a positive electrode current collector is made of aluminium foil or aluminium alloy foil and a positive electrode active material layer contains a lithium composite oxide such as lithium cobaltate. On the other hand, a negative electrode current collector is made of copper foil or copper alloy foil and a negative electrode active material layer contains carbon or the like.

The positive electrode current collector is electrically connected to a positive electrode external terminal attached to a battery case with a positive electrode current-collecting lead therebetween. On the other hand, the negative electrode current collector is connected to a negative electrode external terminal attached to the battery case with a negative electrode current-collecting lead therebetween. In general, resistance welding is used to join the negative electrode current collector and the negative electrode current-collecting lead together.

Japanese Published Unexamined Patent Application No. 2013-251048 (Patent Document 1) discloses invention relating to a nonaqueous electrolyte secondary battery for increasing the welding strength of a weld in a negative electrode current collector. In the nonaqueous electrolyte secondary battery, the negative electrode current collector used is chromate coating layer-formed copper foil surface-treated with a chromate. At least one surface portion of the negative electrode current collector that is joined to a negative electrode terminal and a portion therearound are provided with a copper oxide coating layer made of copper oxide.

This configuration increases the welding strength of a weld between the negative electrode current collector and the negative electrode terminal.

The inventors have found that, apart from the welding strength of a weld in a negative electrode current collector, secondary batteries with low welding strength may possibly be manufactured because the difference between lots of negative electrode current collectors causes a variation in welding strength, even though specifications (thickness, resistivity, tensile strength, and the like) of the negative electrode current collectors are the same and resistance welding conditions are the same.

### BRIEF SUMMARY OF THE INVENTION

The present invention has been made in view of this fact. It is a main object of the present invention to reduce the variation in welding strength of a resistance weld between a negative electrode current collector and a negative electrode current-collecting lead to achieve high welding strength.

A secondary battery according to the present invention includes an electrode assembly including a positive electrode which includes a positive electrode current collector and a positive electrode active material layer placed thereon and a negative electrode which includes a negative electrode current collector and a negative electrode active material layer placed thereon and a battery case in which the electrode assembly is housed. The negative electrode current collector is connected to a negative electrode external terminal attached to the battery case with a negative electrode current-collecting lead therebetween. The negative electrode current collector and the negative electrode current-collecting lead are joined together with a resistance weld. The negative electrode current collector is composed of copper foil or copper alloy foil. The diffraction intensity I(111) of a (111) orientation on a principal surface of the negative electrode current collector that is located on the negative electrode current-collecting lead side is larger than the diffraction intensity of another orientation as determined by X-ray diffraction.

A method for manufacturing the secondary battery according to present invention includes a step of joining the negative electrode current collector and the negative electrode current-collecting lead together by resistance welding in such a manner that the negative electrode current-collecting lead is placed so as to abut the negative electrode current collector and the negative electrode current-collecting lead is pressed against the negative electrode current collector.

According to the present invention, the variation in welding strength of a resistance weld between a negative electrode current collector and a negative electrode current-collecting lead can be reduced and high welding strength can be achieved.

### BRIEF DESCRIPTION OF THE SEVERAL VIEWS OF THE DRAWINGS

FIG. 1A is a front view showing the internal structure of a secondary battery according to an embodiment of the present invention;

FIG. 1B is a sectional view of the secondary battery taken along the line IB-IB of FIG. 1A;

FIG. 2 is a sectional view of the secondary battery taken along the line II-II of FIG. 1A;

FIG. 3A is a graph showing the relationship between the diffraction intensity and orientation of a negative electrode current collector according to a lot in which no welding failure occurred as determined by X-ray diffraction;

FIG. 3B is a graph showing the relationship between the diffraction intensity and orientation of a negative electrode current collector according to a lot in which a welding failure occurred as determined by X-ray diffraction;

FIG. 4A is a schematic view showing a state in which a negative electrode current-collecting lead is pressed against a negative electrode current collector in a case where the crystal lattice (111) plane of the negative electrode current collector is perpendicular to a pressing direction; and

FIG. 4B is a schematic view showing a state in which a negative electrode current-collecting lead is pressed against a negative electrode current collector in a case where the crystal lattice (100) plane of the negative electrode current collector is perpendicular to a pressing direction.

### DETAILED DESCRIPTION OF THE INVENTION

### Embodiments

Embodiments of the present invention will now be described with reference to the accompanying drawings. Preferred embodiments below are essentially for illustrative purposes only and are not in any way intended to limit the present invention, applications thereof, or uses thereof.

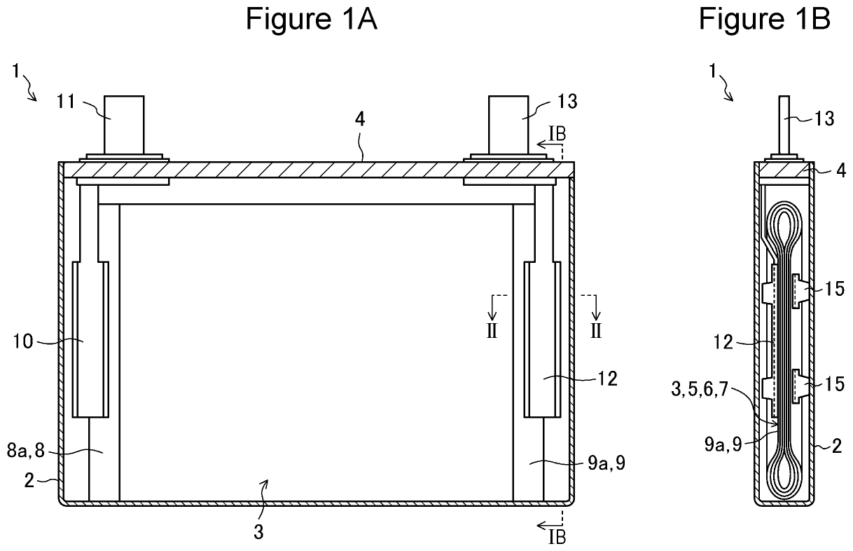

FIGS. 1A and 1B show the configuration of a secondary battery 1 according to an embodiment of the present invention. FIG. 1A is a front view showing the internal structure of the secondary battery 1 (a side surface of a portion of a battery case 2 below is excluded for the purpose of showing the inside thereof). FIG. 1B is a sectional view of the secondary battery 1 taken along the line IB-IB of FIG. 1A. The secondary battery 1 is a prismatic lithium ion battery and includes the battery case 2. The battery case 2 is made of aluminium or an aluminium alloy. A flat wound electrode assembly 3 is housed in the battery case 2. The battery case 2 has an opening sealed with a sealing plate 4 made of aluminium or an aluminium alloy.

The wound electrode assembly 3 includes a positive electrode and a negative electrode. In particular, as shown in FIG. 1B, the wound electrode assembly 3 has a structure in which a positive electrode plate 5, a negative electrode plate 6, and separators 7 are wound a plurality of times in such a state that the positive electrode plate 5 and the negative electrode plate 6 are insulated from each other with the separators 7. As shown in FIG. 1B, the wound electrode assembly 3 has a flat shape.

The positive electrode plate 5 includes a plate-shaped positive electrode current collector 8 and positive electrode active material layers (not shown) placed on both surfaces of the positive electrode current collector 8. The positive electrode current collector 8 is made of aluminium foil or aluminium alloy foil with a thickness of about 10 μm to 20 μm. The positive electrode active material layers contain a lithium composite oxide such as lithium cobaltate, a conductive material made of a carbon material or the like, and a binder. The positive electrode active material layers are placed on both surfaces of the positive electrode current collector 8 except end portions of one lateral side (one side of the wound electrode assembly 3 in a winding axis direction thereof, or the left side in FIG. 1A) of the positive electrode current collector 8. That is, the end portions of one lateral side of the positive electrode current collector 8 are positive electrode current collector exposed portions 8a not covered by the positive electrode active material layers.

The negative electrode plate 6 includes a plate-shaped negative electrode current collector 9 and negative electrode active material layers (not shown) placed on both surfaces of the negative electrode current collector 9. The negative electrode current collector 9 preferably contains 95% by mass or more of copper and more preferably 99% by mass or more of copper. The negative electrode current collector 9 is preferably made of copper foil or copper alloy foil with a thickness of about 5 μm to 20 μm. The negative electrode active material layers contain a negative electrode active material made of a carbon material or the like, a binder, and the like. The negative electrode active material layers are placed on both surfaces of the negative electrode current collector 9 except end portions of the other lateral side (the other side of the wound electrode assembly 3 in the winding axis direction thereof, or the right side in FIG. 1A) of the negative electrode current collector 9. That is, the end portions of the other lateral side of the negative electrode current collector 9 are negative electrode current collector exposed portions 9a not covered by the negative electrode active material layers.

That is, the wound electrode assembly 3 includes a plurality of the stacked positive electrode current collector exposed portions 8a, which are located at an end portion of one side (the left side in FIG. 1A) in a width direction (winding axis direction) and a plurality of the stacked negative electrode current collector exposed portions 9a, which are located at an end portion of the other side (the right side in FIG. 1A).

The separators 7 include a microporous membrane made of a polyolefin. The separators 7 preferably have a width sufficient to cover the positive electrode active material layers and the negative electrode active material layers.

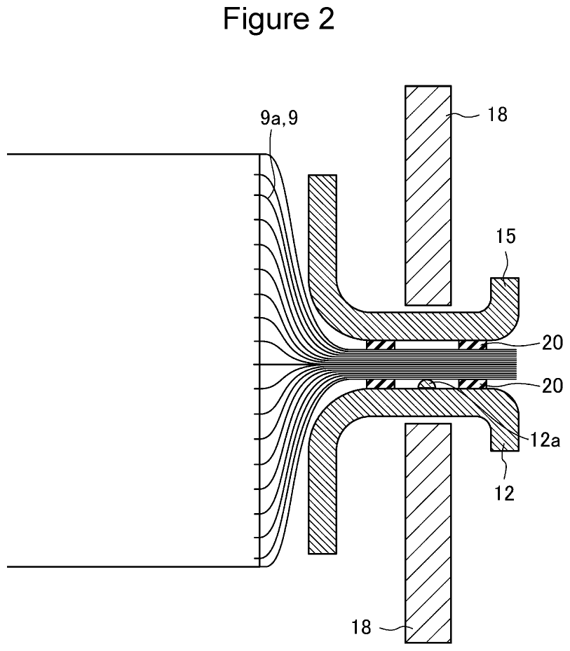

FIG. 2 is a sectional view of the secondary battery 1 taken along the line II-II of FIG. 1A. That is, FIG. 2 shows the internal structure of the battery case 2 on the negative electrode side (the right side in FIG. 1A) where the negative electrode current collector exposed portions 9a are located. As shown in FIG. 2, a plurality of the negative electrode current collector exposed portions 9a converge to a central portion in the thickness direction to form a bundle. A bundle of a plurality of the negative electrode current collector exposed portions 9a (a bundle of the negative electrode current collector 9) is electrically connected to a negative electrode external terminal 13 with a negative electrode current-collecting lead 12 therebetween, the negative electrode external terminal 13 being attached to the sealing plate 4 of the battery case 2 with an insulating member therebetween.

Likewise, as shown in FIG. 1A, a plurality of the positive electrode current collector exposed portions 8a are electrically connected to a positive electrode external terminal 11 with a positive electrode current-collecting lead 10 therebetween, the positive electrode external terminal 11 being attached to the sealing plate 4 of the battery case 2 with an insulating member therebetween.

The positive electrode current-collecting lead 10 and the positive electrode external terminal 11 are made of aluminium or an aluminium alloy. The negative electrode current-collecting lead 12 and the negative electrode external terminal 13 are made of copper or a copper alloy.

As shown in FIG. 2, the negative electrode current-collecting lead 12 and a negative electrode current collector-receiving member 15 are connected to both outer surfaces of the bundle of the negative electrode current collector exposed portions 9a. A surface of the negative electrode current-collecting lead 12 is provided with a projecting portion 12a. That is, the bundle of the negative electrode current collector exposed portions 9a interposed between the projecting portion 12a of the negative electrode current-collecting lead 12 and the negative electrode current collector-receiving member 15. The negative electrode current collector-receiving member 15 is made of copper or a copper alloy. An insulating film 20 is placed between the negative electrode current-collecting lead 12 and the bundle of the negative electrode current collector exposed portions 9a and extends around a portion where the negative electrode current-collecting lead 12 and the negative electrode current collector exposed portions 9a are joined together. An insulating film 20 is placed between the bundle of the negative electrode current collector exposed portions 9a and the negative electrode current collector-receiving member 15 and extends around a portion where the negative electrode current collector exposed portions 9a and the negative electrode current collector-receiving member 15 are joined together. Each of the insulating films 20 is preferably placed at a predetermined position because the increase of a current not used for resistance welding can be suppressed. The insulating films 20 are not essential components and may be omitted. The projecting portion 12a is not an essential component and the negative electrode current-collecting lead 12 need not be provided with the projecting portion 12a. The negative electrode current collector-receiving member 15 is not an essential component and may be omitted.

The bundle of the negative electrode current collector exposed portions 9a (the negative electrode current collector 9) and the negative electrode current-collecting lead 12 are resistance-welded together by a method below.

First, the negative electrode current-collecting lead 12, which includes the projecting portion 12a on a surface thereof, and the negative electrode current collector-receiving member 15 are prepared. Next, as shown in FIG. 2, the negative electrode current-collecting lead 12 and the negative electrode current collector-receiving member 15 are placed on both sides of the bundle of the negative electrode current collector exposed portions 9a so as to sandwich the bundle of the negative electrode current collector exposed portions 9a. In this operation, the projecting portion 12a of the negative electrode current-collecting lead 12 is arranged to abut the negative electrode current collector exposed portions 9a. Next, welding electrodes 18 made of copper or a copper alloy are placed on both sides of the negative electrode current-collecting lead 12 and the negative electrode current collector-receiving member 15. Both of the welding electrodes 18 are arranged to abut the negative electrode current-collecting lead 12 and the negative electrode current collector-receiving member 15 from both sides and are pressed against the negative electrode current-collecting lead 12 and the negative electrode current collector-receiving member 15 so as to sandwich the negative electrode current-collecting lead 12 and the negative electrode current collector-receiving member 15. This allows the negative electrode current-collecting lead 12, the bundle of the negative electrode current collector exposed portions 9a, and the negative electrode current collector-receiving member 15 to be electrically connected to each other. Next, a welding current is applied between the welding electrodes 18 in such a manner that the welding electrodes 18 pressed against each other. This allows the negative electrode current collector 9 (the negative electrode current collector exposed portions 9a), the negative electrode current-collecting lead 12 (the projecting portion 12a), and the negative electrode current collector-receiving member 15 to be joined together by resistance welding (the junction of the negative electrode current collector 9, the negative electrode current-collecting lead 12, and the negative electrode current collector-receiving member 15 forms a resistance weld).

By the way, the inventors have found that secondary batteries with low welding strength may possibly be manufactured because the difference between lots of negative electrode current collectors causes a variation in welding strength, even though specifications (thickness, resistivity, tensile strength, and the like) of the negative electrode current collectors are the same and resistance welding conditions are the same.

When impact or vibration is applied to the secondary battery 1, a load may possibly be applied to a resistance weld between the negative electrode current collector 9 (the negative electrode current collector exposed portions 9a) and the negative electrode current-collecting lead 12 (the projecting portion 12a). Since the negative electrode active material expands and contracts significantly in association with the storage and release of lithium ions during charge and discharge, a load may possibly be applied to the resistance weld between the negative electrode current collector 9 (the negative electrode current collector exposed portions 9a) and the negative electrode current-collecting lead 12 (the projecting portion 12a).

The negative electrode current collector 9 and the negative electrode current-collecting lead 12 are resistance-welded together in such a manner that a current is applied therebetween in such a state that the negative electrode current-collecting lead 12 is firmly pressed against the negative electrode current collector 9 with the welding electrodes 18. In particular, a surface of the negative electrode current-collecting lead 12 is provided with fine bumps (hereinafter referred to as “micro-bumps”) and the micro-bumps of the negative electrode current-collecting lead 12 extend into the negative electrode current collector 9 (the negative electrode current collector exposed portions 9a). The micro-bumps are very smaller than the projecting portion 12a. A surface of the projecting portion 12a is provided with a plurality of micro-bumps. These micro-bumps extend into the negative electrode current collector 9.

In usual, a current is applied between the negative electrode current collector 9 and the negative electrode current-collecting lead 12 in such a state that the negative electrode current-collecting lead 12 is pressed against the negative electrode current collector 9 with a constant pressure. If the indentation depth of the micro-bumps of the negative electrode current-collecting lead 12 in the negative electrode current collector 9 varies against the constant pressure, then the contact area between the negative electrode current-collecting lead 12 and the negative electrode current collector 9 varies. If the contact area therebetween varies, then the current density also varies, resulting in that the melting of the negative electrode current collector 9 is instable.

Therefore, the inventors have conceived that the variation in indentation depth of the micro-bumps of the negative electrode current-collecting lead 12 in the negative electrode current collector 9 causes a variation in welding strength and have focused on the crystal orientation of copper or copper alloy foil.

That is, the crystal structure of copper or copper alloy foil is a face-centered cubic lattice and therefore the displacement due to the application of a constant pressure varies depending on the orientation of crystals. In usual, copper or copper alloy foil used to form the negative electrode current collector 9 is controlled so as to have characteristics such as certain resistivity ad tensile strength and is not at all controlled for orientation. Therefore, the inventors have conceived that, if the orientation of copper or copper alloy foil forming the negative electrode current collector 9 varies, then the indentation depth of the micro-bumps of the negative electrode current-collecting lead 12 in the negative electrode current collector 9 varies and, as a result, a variation in welding strength occurs.

Therefore, it has been verified that the variation in indentation depth of the micro-bumps of the negative electrode current-collecting lead 12 in the negative electrode current collector 9 causes a variation in welding strength. For this purpose, for a lot in which a welding failure occurred in a weld between a negative electrode current collector 9 and a negative electrode current-collecting lead 12 and a lot in which no welding failure occurred, the crystal orientation of the negative electrode current collector 9 used in each lot in a thickness direction thereof was investigated by X-ray diffraction on a principal surface of the negative electrode current collector 9 that was placed on the negative electrode current-collecting lead 12 side. The negative electrode current collector 9 was one made of electrolytic copper foil.

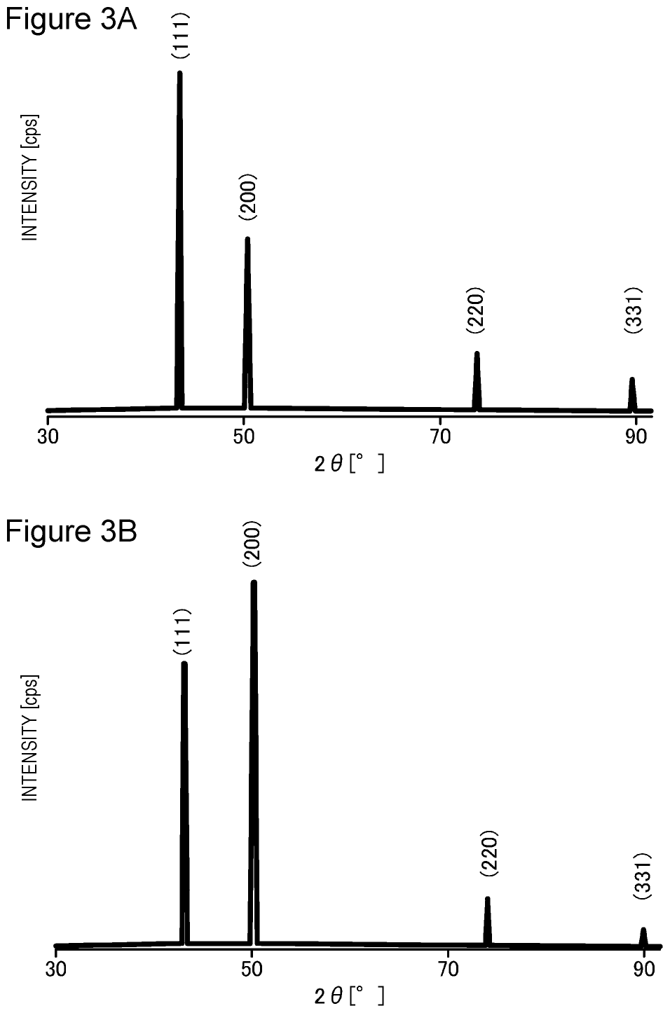

The results are shown in FIGS. 3A and 3B. FIG. 3A shows the relationship between the diffraction intensity and orientation on a principal surface of the negative electrode current collector (copper foil) 9 according to the lot in which no welding failure occurred as determined by X-ray diffraction, the principal surface being placed on the negative electrode current-collecting lead 12 side. FIG. 3B shows the relationship between the diffraction intensity and orientation on a principal surface of copper foil as the negative electrode current collector 9 according to the lot in which the welding failure occurred as determined by X-ray diffraction, the principal surface being placed on the negative electrode current-collecting lead 12 side. In FIGS. 3A and 3B, the horizontal axis represents the diffraction angle (20) and the diffraction intensity (cps).

As is clear from FIG. 3A, in copper foil as the negative electrode current collector 9 according to the lot in which no welding failure occurred, the diffraction intensity I(111) of a (111) orientation is largest (larger than the diffraction intensity of another orientation) as determined by X-ray diffraction. However, as is clear from FIG. 3B, in copper foil as the negative electrode current collector 9 according to the lot in which the welding failure occurred, the diffraction intensity I(200) of a (200) orientation is largest.

This result is explained as described below.

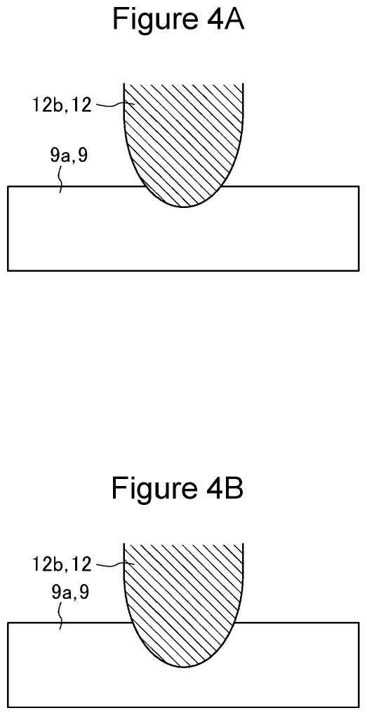

FIGS. 4A and 4B show a state in which a micro-bump 12b of a negative electrode current-collecting lead 12 is pressed against a negative electrode current collector 9 (negative electrode current collector exposed portions 9a). FIG. 4A shows a case where the crystal lattice (111) plane of the negative electrode current collector 9 is perpendicular to a pressing direction. FIG. 4B shows a case where the crystal lattice (100) plane of the negative electrode current collector 9 is perpendicular to the pressing direction. Although fine bumps similar to the micro-bump 12b of the negative electrode current-collecting lead 12 are present on a surface of the negative electrode current collector 9, the fine bumps are not shown.

The crystal structure of copper is a face-centered cubic lattice and therefore the (111) plane is the slip plane. That is, as shown in FIG. 4A, in a case where, for example, the micro-bump 12b of the negative electrode current-collecting lead 12 is pressed perpendicularly to the (111) plane of the negative electrode current collector 9, the displacement of the negative electrode current collector 9 by pressing is small; hence, the contact area is small and the current density is high. Thus, the negative electrode current collector 9 is likely to be locally heated to a high temperature and the negative electrode current collector 9 is likely to be melted; hence, welding strength due to resistance welding is high.

However, as shown in FIG. 4B, in a case where, for example, the micro-bump 12b of the negative electrode current-collecting lead 12 is pressed perpendicularly to the (100) plane of the negative electrode current collector 9, the displacement of the negative electrode current collector 9 by pressing is large; hence, the contact area is large and the current density is low. Thus, the negative electrode current collector 9 is unlikely to be heated to a high temperature and the negative electrode current collector 9 is unlikely to be melted; hence, welding strength due to resistance welding is low.

In other words, when the diffraction intensity I(111) of the (111) orientation is large, that is, when the orientation of the (111) plane is predominant, the welding strength is high. Thus, it is conceivable that the variation in welding strength of a resistance weld between the negative electrode current collector 9 (the negative electrode current collector exposed portions 9a) and the negative electrode current-collecting lead 12 can be suppressed to a low level in such a manner that the crystal orientation of the negative electrode current collector 9 is controlled such that the orientation of the (111) plane is predominant.

Furthermore, it is conceivable that reducing the variation of welding strength enables secondary batteries with low welding strength to be prevented from being manufactured and enables high welding strength to be achieved.

From the above finding, for batteries in which the welding strength varied between lots, the relationship between the diffraction intensity I(111) of a (111) orientation and the welding strength was further verified.

In this verification, a negative electrode current collector 9 used was electrolytic copper foil with a thickness of 10 μm. The number of layers of the negative electrode current collector 9 by winding was 37. Resistance welding conditions were a current of 24.5 kA to 25.1 kA, a welding time of 5.4 ms to 5.8 ms, and a weld force of 110 kgf.

After a secondary battery 1 was repeatedly charged and discharged under conditions below, a battery case 2 was disassembled and the joint state of a weld was checked by continuity determination using a tester. A case where continuity could be confirmed with the tester was judged OK. A case where continuity could not be confirmed with the tester was judged NG. Charge/discharge conditions were a temperature of 60° C., a current of 60 A, a charge/discharge voltage of 4.1 V to 2.5 V, and a cycle number of 200 cycles.

Obtained results are shown in Table 1.

TABLE 1

| | | | Welding NG number |
|---|---|---|---|
| | I(111)/Iₐₗₗ | I(111)/I(200) | (in 12 cells) |
| Lot 1 | 0.39 | 0.78 | 3 |
| Lot 2 | 0.46 | 1.19 | 0 |
| Lot 3 | 0.49 | 1.31 | 0 |
| Lot 4 | 0.50 | 1.49 | 0 |
| Lot 5 | 0.51 | 1.57 | 0 |
| Lot 6 | 0.52 | 1.64 | 0 |
| Lot 7 | 0.55 | 1.94 | 0 |
| Lot 8 | 0.58 | 2.38 | 0 |

As shown in Table 1, in this verification, Lots 1 to 8 were aimed and 12 cells were extracted from each lot. The term “welding NG number” refers to the number of cells in which a weld was judged NG with the tester in 12 cells extracted from each lot.

The term “I(111)/Iₐₗₗ” refers to the ratio of the diffraction intensity I(111) to the sum Iₐₗₗ of the diffraction intensities of all orientations as determined by X-ray diffraction. Incidentally, in this verification, Iₐₗₗ is the sum of I(111), I(200), I(220), and I(331), that is, Iₐₗₗ=I(111)+I(200)+I(220)+I(331). This is because, as is clear from FIGS. 3A and 3B, the diffraction intensity of an orientation other than I(111), I(200), I(220), and I(331) is negligibly low.

As is clear from Table 1, in Lot 1, the welding NG number is three cells in 12 cells. However, in Lots 2 to 8, the welding NG number is zero in 12 cells. That is, it can be said that a welding failure occurred only in Lot 1 and no welding failure occurred in Lots 2 to 8.

The following relationship can be found: a relationship that when the diffraction intensity ratio (orientation ratio) I(111)/Iₐₗₗ of a (111) orientation is greater than or equal to a certain value, particularly 0.46 or more, no welding failure occurs. That is, it is conceivable that when the diffraction intensity ratio (orientation ratio) I(111)/Iₐₗₗ of the (111) orientation is greater than or equal to a certain value (0.46 or more), the variation in indentation depth of a micro-bump 12b of a negative electrode current-collecting lead 12 in the negative electrode current collector 9 (negative electrode current collector exposed portions 9a) is small and, as a result, the variation of welding strength is reduced. This probably enables secondary batteries with low welding strength to be prevented from being manufactured and enables high welding strength to be achieved.

Since the displacement of the (111) orientation is smallest, it is conceivable that adjusting the diffraction intensity ratio I(111)/Iₐₗₗ of the (111) orientation to a certain value or more enables the current necessary for resistance welding to be reduced.

From FIGS. 3A and 3B, it can be confirmed that a feature common to the negative electrode current collectors 9 according to each lot in which no welding failure occurred and the negative electrode current collector 9 according to the lot in which the welding failure occurred is that I(111) and I(200) are larger than the diffraction intensities of other orientations, particularly I(220) and I(331). In the negative electrode current collectors 9 according to the lot in which no welding failure occurred, I(111) is larger than the diffraction intensities of other orientations including I(200). However, in the negative electrode current collector 9 according to the lot in which the welding failure occurred, I(200) is larger than the diffraction intensities of other orientations including I(111).

That is, the following relationship can be found: a relationship that when I(111)/I(200) is greater than or equal to a certain value, particularly 1 or more (at least 1.19 or more), no welding failure occurs as shown in Table 1.

As described above, the secondary battery 1 according to this embodiment is such that the negative electrode current collector 9 is composed of copper foil or copper alloy foil and the diffraction intensity I(111) of the (111) orientation on the principal surface of the negative electrode current collector 9 that is located on the negative electrode current-collecting lead 12 side is larger than the diffraction intensities of other orientations as determined by X-ray diffraction; hence, the variation in welding strength of a resistance weld between the negative electrode current collector 9 and the negative electrode current-collecting lead 12 can be reduced and high welding strength can be achieved.

The variation of welding strength can be reduced in such a manner that the crystal orientation of copper foil or copper alloy foil as the negative electrode current collector 9 is controlled such that I(111)/Iₐₗₗ is 0.46 or more.

While the present invention has been described above with reference to preferred embodiments, such descriptions are not limitations and various modifications can be made. For example, the negative electrode current-collecting lead 12 may be configured so as not to include the projecting portion 12a. The welding electrodes 18 may be allowed to abut the negative electrode current collector 9 (the negative electrode current collector exposed portions 9a) without using the negative electrode current collector-receiving member 15. In the above embodiment, as the negative electrode current collector 9, electrolytic copper is used. Not only this, but also, for example, rolled copper foil may be used. The negative electrode current collector 9 may be made of copper alloy foil rather than copper foil. The secondary battery 1 is not limited to a lithium ion battery and may be, for example, a nickel-hydrogen battery. The secondary battery 1 may have any configuration, provided that the negative electrode current collector 9 and the negative electrode current-collecting lead 12 are joined together with a resistance weld.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A secondary battery comprising:
an electrode assembly including a positive electrode which includes a positive electrode current collector and a positive electrode active material layer placed thereon and a negative electrode which includes a negative electrode current collector and a negative electrode active material layer placed thereon; and
a battery case in which the electrode assembly is housed,
wherein the negative electrode current collector is connected to a negative electrode external terminal attached to the battery case with a negative electrode current-collecting lead therebetween, the negative electrode current collector and the negative electrode current-collecting lead are joined together with a resistance weld, the negative electrode current collector is composed of copper foil or copper alloy foil, and the diffraction intensity I(111) of a (111) orientation on a principal surface of the negative electrode current collector that is located on the negative electrode current-collecting lead side is larger than the diffraction intensity of another orientation as determined by X-ray diffraction.

2. The secondary battery according to claim 1, wherein the negative electrode current collector is such that the ratio I(111)/Iₐₗₗ of the diffraction intensity I(111) to the sum Iₐₗₗ of the diffraction intensities of all orientations on the principal surface of the negative electrode current collector that is located on the negative electrode current-collecting lead side is 0.46 or more as determined by X-ray diffraction.

3. The secondary battery according to claim 1, wherein the negative electrode current collector is composed of copper foil or copper alloy foil which contains 99% by mass or more of copper and which has a thickness of 5 μm to 20 μm.

4. A method for manufacturing the secondary battery according to claim 1, comprising a step of joining the negative electrode current collector and the negative electrode current-collecting lead together by resistance welding in such a manner that the negative electrode current-collecting lead is placed so as to abut the negative electrode current collector and the negative electrode current-collecting lead is pressed against the negative electrode current collector.

5. The method according to claim 4, wherein a surface of the negative electrode current-collecting lead is provided with a projecting portion and resistance welding is performed in such a state that the projecting portion of the negative electrode current collector is placed so as to abut the negative electrode current collector.
